(19) United States
(12) Patent Application Publication
(10) Pub. No.: US 2003/0065110 A1
(43) Pub. Date: Apr. 3, 2003

(54) Stabilization of acrolein

(76) Inventors: Stephane Lepizzera, Saint Avold (FR); Michel Fauconet, Valmont (FR)

Correspondence Address: SMITH, GAMBRELL & RUSSELL, LLP, 1850 M STREET, N.W., SUITE 800, WASHINGTON, DC, 20036, US

(21) Appl. No.: 10/231,231

(22) Filed: Aug. 30, 2002

(30) Foreign Application Priority Data
Aug. 30, 2001 (FR) 01.11241

(51) Int. Cl. C08F 2/38

(52) U.S. Cl. 526/82

(57) ABSTRACT

At least one nitroxide derivative is used to stabilize pure acrolein or highly concentrated solutions thereof (acrolein content ≧90% by weight), in contact with an essentially anaerobic atmosphere.

### FIELD OF THE INVENTION

The invention relates to the field of acrylic monomers and its subject is, more particularly, stabilization of acrolein to prevent it from self-polymerizing during its purification, storage or transportation.

### BACKGROUND OF THE INVENTION

The most commonly used process for producing acrolein comprises a reaction section in which is performed a gas-phase catalytic oxidation of propylene with atmospheric oxygen, and a purification section to remove the reaction by-products that are mainly carbon oxides, acrylic acid, acetic acid and acetaldehyde.

A standard purification process comprises a first “essentially aqueous” section in which the following are successively carried out:

cooling of the aqueous reaction flow (quench);

absorption with water, in a first column, of the organic acids (acrylic acid and acetic acid);

absorption with cold water of the acrolein in a second column with removal at the top of the non-condensed gases (non-converted propylene, nitrogen, oxygen and carbon oxides) and recovery at the column tail of a dilute aqueous acrolein solution;

removal of the water at the bottom of a third column, at the top of which the acrolein is recovered.

For certain uses of acrolein, it is often found to be necessary to complete the purification in a second purification section known as an “essentially organic section”, comprising a fourth column to remove light compounds (in particular acetaldehyde) at the top and a final column for removal of the heavy compounds.

One of the delicate points in the purification of acrolein arises from the fact that this monomer, and likewise the acrylic acid contained in the crude solutions derived from the reaction section, readily undergoes a self-polymerization reaction initiated by temperature-promoted free-radical reactions. As a result, the flows present in the purification steps, which are carried out at high temperature (especially in the distillation columns), are the most sensitive to this phenomenon. A second factor that favours the polymerization of acrolein is the formation of peroxides, which are readily generated by the action of oxygen on the monomer and are known to rapidly initiate its polymerization. To attenuate this problem, it is generally sought to reduce the presence of oxygen in the medium, but this can have an adverse effect on the efficacy of certain polymerization inhibitors added in the process.

The polymers generated have the particular feature of being insoluble in the monomer, in the crude media containing the monomer to be purified and in mixtures of the monomer with the solvents used in the purification process, in particular in aqueous media. The generation of these insoluble polymers in industrial distillation equipment leads to blockages involving stoppage of the plant and frequent, difficult and expensive cleaning operations.

To overcome these drawbacks, it is known practice to introduce into the acrolein flows one or more stabilizing molecules such as phenolic compounds (for example hydroquinone, hydroquinone methylether, 2,6-di(t-butyl)-1-hydroxytoluene, etc.), amine derivatives (for example hydroxylamines, hydroxydi-phenylamine, piperidine, etc.), substituted p-phenylenediamines or transition metal salts such as, for example, copper (II) acetate, manganese (II) acetate or copper dibutyldithiocarbamate.

Hydroquinone is often mentioned as an inhibitor in acrolein purification processes; however, it does not effectively reduce the formation of polymers during the acrolein purification steps. The mediocre efficacy of this inhibitor and of phenolic inhibitors in general is explained by the fact that its mechanism of action requires the presence of oxygen which, as indicated above, is an initiator of the formation of peroxides that are detrimental to the stability of the monomer.

### DESCRIPTION OF INVENTION

Other inhibitors are more effective than hydroquinone, but their efficacy is still insufficient to allow functioning of an industrial acrolein purification unit without any problems of reliability.

The present invention is directed towards substantially increasing the stability of acrolein-rich flows, in particular during the steps of the “essentially organic section” of the acrolein purification process. This result is achieved, without additional introduction of oxygen or of an oxygen-containing gaseous flow, by adding at least one nitroxide derivative to the acrolein flow.

One subject of the invention is thus the use of at least one nitroxide derivative to stabilize pure acrolein or highly concentrated solutions thereof (acrolein content ≧90% by weight), in contact with an essentially anaerobic atmosphere, i.e. a gaseous atmosphere containing less than 1% by volume of oxygen. This use relates more particularly to the steps of the essentially organic section of acrolein purification, but also to its storage or transportation under an inert atmosphere.

A subject of the invention is also a process for stabilizing acrolein or an acrolein-rich flow, characterized in that at least one nitroxide derivative is added thereto. The amount of nitroxide derivative to be added may vary within a wide range, but is generally between 10 and 10,000 ppm relative to the weight of acrolein or of flow to be stabilized, and preferably between 50 and 5,000 ppm.

Among the nitroxide derivatives to be used according to the invention, mention may be made of those represented by the general formula:

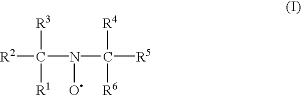

in which the symbols R¹, R², R³ and R⁴, which may be identical or different, represent optionally substituted linear or branched alkyl radicals, the symbols R³ and R⁴ also possibly being linked together; R⁵ is a hydrogen atom or an optionally substituted linear or branched alkyl radical; and R⁶ represents an optionally substituted linear or branched alkyl radical, an aryl radical or a dialkoxyphosphoryl radical. The following are more particularly preferred:

cyclic nitroxides of general formula:

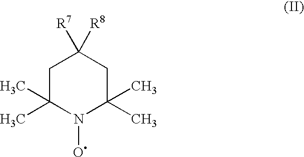

in which R⁷ represents a hydrogen atom or a hydroxyl, acyloxy or amino group, and R⁸ represents a hydrogen atom or, with R⁷, forms an oxo group; and

acyclic nitroxides of general formula:

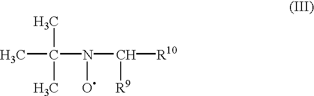

in which R⁹ represents a branched alkyl radical and R¹⁰ represents a phenyl radical or a dialkoxyphosphoryl group.

Non-limiting examples of these preferred nitroxides that may be mentioned include 2,2,6,6-tetramethyl-1-oxylpiperidine (TEMPO) and derivatives thereof substituted in position 4, for instance 4-hydroxy-TEMPO, 4-oxo-TEMPO and 4-amino-TEMPO, and also N-tert-butyl-1-phenyl-2-methylpropyl nitroxide and N-tert-butyl-1-diethylphosphono-2,2-dimethylpropyl nitroxide (SG1 hereinbelow), the structural formula and preparation of which are described in publication WO 96/24620.

The nitroxide derivatives according to the invention, in aqueous or solid form, are mixed with acrolein or the flow to be stabilized and the solutions obtained are then injected into the process, preferably into the feed flow and/or into the top of the distillation column. When these solutions are introduced into the top of the column, the introduction is performed at one or more of the points constituted by the highest plate of the column or by a plate located slightly below this last plate or by the entry of the vapour condenser at the top of the column.

### EXAMPLES

The examples that follow illustrate the invention without limiting it. Unless otherwise mentioned, the parts and percentages are expressed on a weight basis.

### Example 1 (Static Tests)

Crude acrolein (mixture of about 97% acrolein and 3% water) destabilized beforehand by distillation, and then restabilized with 10 ppm of the stabilizer to be studied, are placed in a glass tube. Mounted on this tube is a condenser which is itself closed with a stopper that has a hole to allow a stainless steel rod to pass through. This stainless steel rod serves to purge the acrolein sample continuously with nitrogen. After purging for 20 minutes at ambient temperature, the tube is dipped into a bath thermostatically maintained at 80° C. and the start of polymerization is detected visually. An acrolein stabilization time is then defined for each test stabilizer under the conditions of the test.

The table below collates the results obtained with two stabilizers according to the invention (4-hydroxy-TEMPO and SG1) and, for comparative purposes, hydroquinone, copper dibutyldithiocarbamate (CB hereinbelow) and phenothiazine.

| Stabilizer | Stabilization time | |
|---|---|---|
| 4-OH-TEMPO | >4 | h |
| SG1 | >4 | h |
| Hydroquinone | 1 | mm |
| CD | 5 | mm |
| Phenothiazine | 10 | mm |

### Examples 2 to 4 (Dynamic Tests)

The dynamic tests, intended to compare the efficacy of the stabilizers, were performed in an assembly for simulating a distillation column of the acrolein purification process. This column, chosen from among the most sensitive of the process on account of the high concentration of monomer in the flow, is the column for separating out the light impurities, in particular acetaldehyde.

The experimental assembly consists of:

a glass column with an inside diameter of 36 mm, comprising 2 sections 14 cm in height each equipped with a stainless steel packing element of multiknit type,

a thermosiphon boiler at the column tail, heated by electrical resistance, and

a condenser in which circulates water at 12° C., at the top.

The feed mixture consists of acrolein (93%), acetaldehyde (4%) and water (3), to which is also added 0.1% of polymerization inhibitor to be tested. This mixture is introduced at a rate of 185 g/h between the two sections of the column. The same rate of column tail flow is removed continuously using the boiler, so as to keep a constant level of liquid in the boiler. The residence time of the column tail flow in the boiler is one hour. The heating power applied to the boiler is adapted so as to obtain a sufficient rate of liquid reflux in the condenser at the top of the column.

The tests are performed at atmospheric pressure. The temperatures measured are 53° C. in the boiler, 50° C. in the feed and 19° C. at the top of the column. The formation of polymer is assessed comparatively, by observation of the deposits in the assembly.

### Example 2

The polymerization inhibitor tested is 4-hydroxy-TEMPO, dissolved to a concentration of 0.1% by weight in the feed mixture. The column tail flow extracted from the boiler is clear and uncloudy. After running for 3 hours, no trace of solid deposit is observed in the assembly.

### Example 3 (Comparative)

The polymerization inhibitor tested is hydroquinone, dissolved in the feed mixture to a concentration of 0.1% by weight. During the test, it is noted that the liquid flow extracted from the column tail is cloudy, denoting the presence of insoluble polymers in fine suspension in the medium. After running for 3 hours, a white solid deposit as a fine layer coating the inner wall of the boiler over about half of its area, and a white solid deposit as grains in the lower part of the boiler are observed.

### Example 4 (Comparative)

The same type of test is repeated with hydroquinone methyl ether dissolved to a proportion of 0.1% by weight in the feed mixture. The column tail flow removed during the operation is cloudy. After a test time of 3 hours, a fine layer of white solid coating the inner wall of the boiler over about one-third of its area, and a light deposit of white solid as grains in the lower part of the boiler are observed.

### Example 5

The process is performed as in Examples 2 to 4, except that the mixture to be tested, of the same composition as in the preceding tests, is not introduced and removed continuously. It is the column tail flow that is returned continuously, at a flow rate of 200 g/h, into the feed point between the two sections of the column. The duration of this second dynamic test is 24 hours.

The inhibitor is 4-OH-TEMPO, dissolved in the feed mixture to a proportion of 0.1%. After running for 24 hours, the column is totally free of solid deposit and no significant deposit is observed on the inner wall of the boiler.

### Example 6 (Comparative)

The test of Example 5 is repeated, but replacing the 4-OH-TEMPO with hydroquinone added in a proportion of 0.1% to the feed flow. After running for 16 hours, the test has to be stopped as a result of blockage of the feed pipe. The column tail flow contains polymers in suspension. The inner wall of the boiler is covered with a thin layer of white solid over about ⅔ of its surface and a thick deposit of viscous polymer can be seen in the bottom of the boiler, and also a few solids in the form of grains which coat the lower part of this boiler.

Although the invention has been described in conjunction with specific embodiments, it is evident that many alternatives and variations will be apparent to those skilled in the art in light of the foregoing description. Accordingly, the invention is intended to embrace all of the alternatives and variations that fall within the spirit and scope of the appended claims. The foregoing references are hereby incorporated by reference.

1. Method for stabilization comprising stabilizing acrolein in acrolein flows containing at least 90% by weight of this monomer, during its purification, storage or transportation by treatment with at least one nitroxide compound.

2. Method according to claim 1, wherein the acrolein-rich flow is placed in contact with a gaseous atmosphere containing less than 1% oxygen by volume.

3. Method according to claim 1, wherein the nitroxide compound corresponds to the formula: 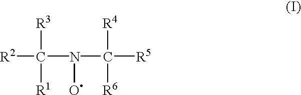
in which the symbols R¹, R², R³ and R⁴, which may be identical or different, represent optionally substituted linear or branched alkyl radicals, the symbols R³ and R4 also possibly being linked together; R⁵ is a hydrogen atom or an optionally substituted linear or branched alkyl radical; and R⁶ represents an optionally substituted linear or branched alkyl radical, an aryl radical or a dialkoxyphosphoryl radical.

4. Method according to claim 1, wherein the nitroxide compound is a cyclic nitroxide of formula: 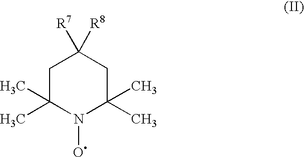
in which R⁷ represents a hydrogen atom or a hydroxyl, acyloxy or amino group, and R⁸ represents a hydrogen atom or, with R⁷, forms an oxo group.

5. Method according to claim 4, wherein the nitroxide compound is 2,2,6,6-tetramethyl-1-oxylpiperidine (TEMPO), 4-hydroxy-TEMPO, 4-oxo-TEMPO or 4-amino-TEMPO.

6. Method according to claim 1, wherein the nitroxide compound is an acyclic nitroxide of formula: 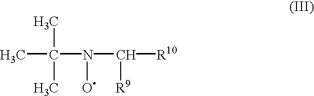
in which R⁹ represents a branched alkyl radical and R¹⁰ represents a phenyl radical or a dialkoxyphosphoryl group.

7. Method according to claim 6, wherein the nitroxide compound is N-tert-butyl-1-diethyl-phosphono-2,2-dimethylpropyl nitroxide or N-tert-butyl-1-phenyl-2-methylpropyl nitroxide.

8. Method according to claim 1, wherein the total concentration of nitroxide compound in the acrolein liquid flow is between 10 ppm and 10,000 ppm relative to the acrolein.

9. Method according to claim 1, wherein the nitroxide compound is used to stabilize the essentially organic section of an acrolein purification process.

10. Method according to claim 8, wherein the liquid flow is between 50 and 500 ppm.
